(19) United States
(12) Patent Application Publication
(10) Pub. No.: US 2008/0200221 A1
(43) Pub. Date: Aug. 21, 2008

(54) Mobile Communication Device Holder

(76) Inventor: Raymond Lockwood, Ajo, AZ (US)

Correspondence Address: HARSHAW RESEARCH, INC., 210 W. TECUMSEH STREET, OTTAWA, KS, 66067, US

(21) Appl. No.: 11/676,343

(22) Filed: Feb. 19, 2007

(51) Int. Cl. H04M 1/00

(52) U.S. Cl. 455/575.1

(57) ABSTRACT

A device for holding at least one mobile communication device includes a rear wall and a pair of side walls connected to the rear wall. A base extends between the side walls for supporting a lower end of at least one mobile communication device. A partition is movably coupled to the rear wall or base for defining a plurality of bays accommodating various communication devices. The base defines a slot through which a power cord electrically connected to a mobile communication device may be extended so for connection to an electrical power source. The device may include an auxiliary framework depending from the base and configured to receive a power strip. A mobile communication device may then be plugged into the power strip in order to recharge the communication device's battery. A solar panel may also be provided as the power source.

### BACKGROUND OF THE INVENTION

The present device relates generally to holding devices and, more particularly, to a mobile communication device holder. The holder may be mounted to a home or office wall and may hold at least one mobile communication device in an organized fashion.

Most adults and even many teenagers have cellular telephones, pagers, or other mobile communication devices. With the increasingly smaller size of these devices, they often are difficult to find when not attached to a person's belt, held in a pocket or purse, or otherwise carried. For example, a family may have multiple mobile communication devices to keep track of in their home or apartment. All of these devices also need to be charged regularly.

Various devices have been proposed in the art for holding electronic devices. Although assumably effective for their intended purposes, the existing proposals and products do not provide a convenient, wall mounted structure for holding a mobile communication device in an organized and strategic manner.

Therefore, it would be desirable to have a mobile communication device holder that holds at least one mobile communications device in an organized manner in which it is easy to locate and keep track of the device(s). Further, it would be desirable to have a holder that is adjustable to hold communication devices of various sizes. In addition, it would be desirable if the holder may also hold a power strip into which a charging cord connected to a mobile communication device may be electrically connected so as to recharge the communication device's battery.

### SUMMARY OF THE INVENTION

A device for holding at least one mobile communication device according to the present invention includes a rear wall and a pair of side walls operatively connected to the rear wall. A base extends between the side walls for supporting a lower end of at least one mobile communication device. In addition, a partition is movably coupled to the rear wall or to the base so as to define a plurality of bays accommodating various communication devices. The base defines a slot through which a power cord electrically connected to a mobile communication device may be extended so as to be plugged into an electrical power source.

The device may also include an auxiliary framework depending from the base and configured to receive or support a power strip. When the power strip is supported in this way, a mobile communication device may be plugged into the power strip in order to recharge the communication device's battery. The holder device may also include a solar panel that may be selectively connected to a mobile communication device with a charging cord for recharging a battery.

Therefore, a general object of the present invention is to provide a device for holding at least one mobile communication device.

Another object of the present invention is to provide a device, as aforesaid, having a plurality of bays and an adjustable partition such that communication devices of various sizes may be held.

Still another object of the present invention is to provide a device, as aforesaid, for supporting at least one communication device as well as a power strip for conveniently electrically connecting the two and recharging the battery of the communication device.

Yet another object of the present invention is to provide a device, as aforesaid, that may include a solar panel for electrical connection to a mobile communication device held by the device.

A further object of the present invention is to provide a device, as aforesaid, that may be mounted to a wall of a home or office so as to hold at least one mobile communication device in an accessible location.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a mobile communication device holder according to a preferred embodiment of the present invention and showing a solar panel as a power source;

FIG. 2 is a perspective view on an enlarged scale of the holder as in FIG. 1;

FIG. 3 is a front view of the holder as in FIG. 2;

FIG. 4 is a perspective view of the holder as in FIG. 2 with one partition shown exploded from the device; and

FIG. 5 is a perspective view of the holder having an auxiliary framework for receiving an electrical power strip and shown holding a mobile communication device and battery charging cord.

### DESCRIPTION OF THE PREFERRED EMBODIMENT

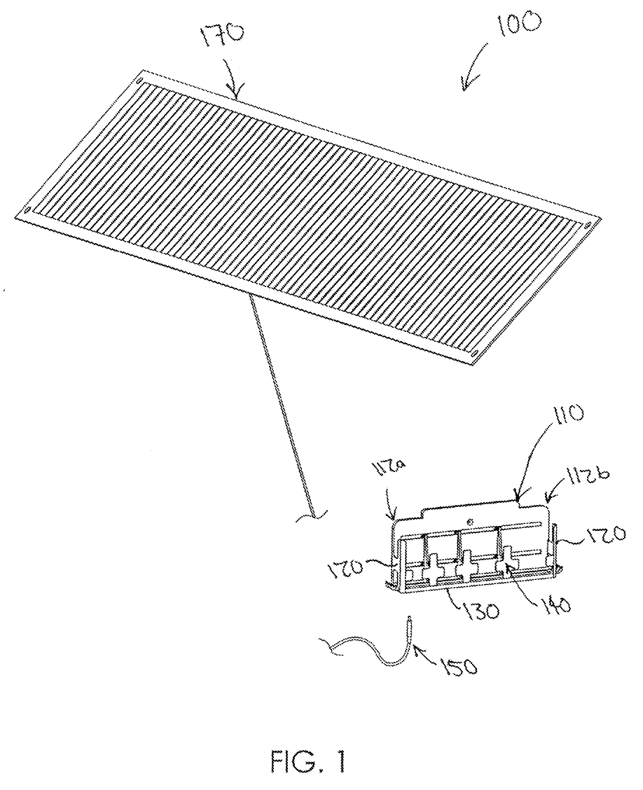

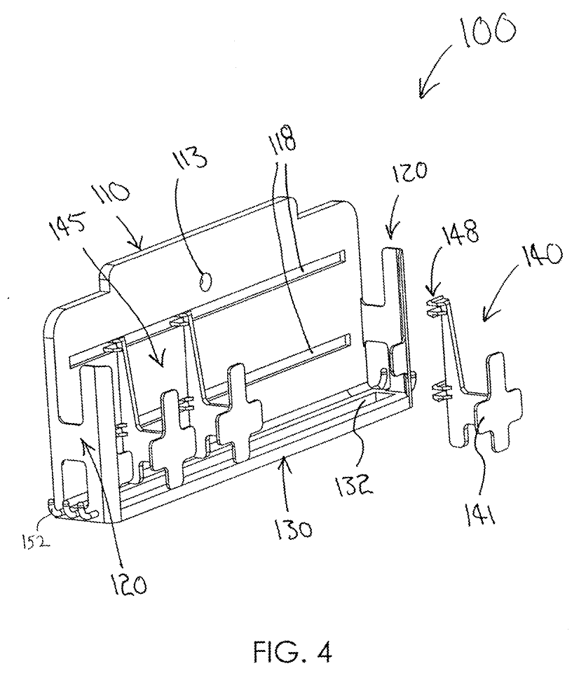

A device 100 for holding at least one mobile communication device 10 according to the present invention will now be described in detail with reference to FIGS. 1 through 5 of the accompanying drawings. More particularly, a holding device 100 according to the current invention includes a rear wall 110, a pair of side walls 120, a base 130, and a partition 140.

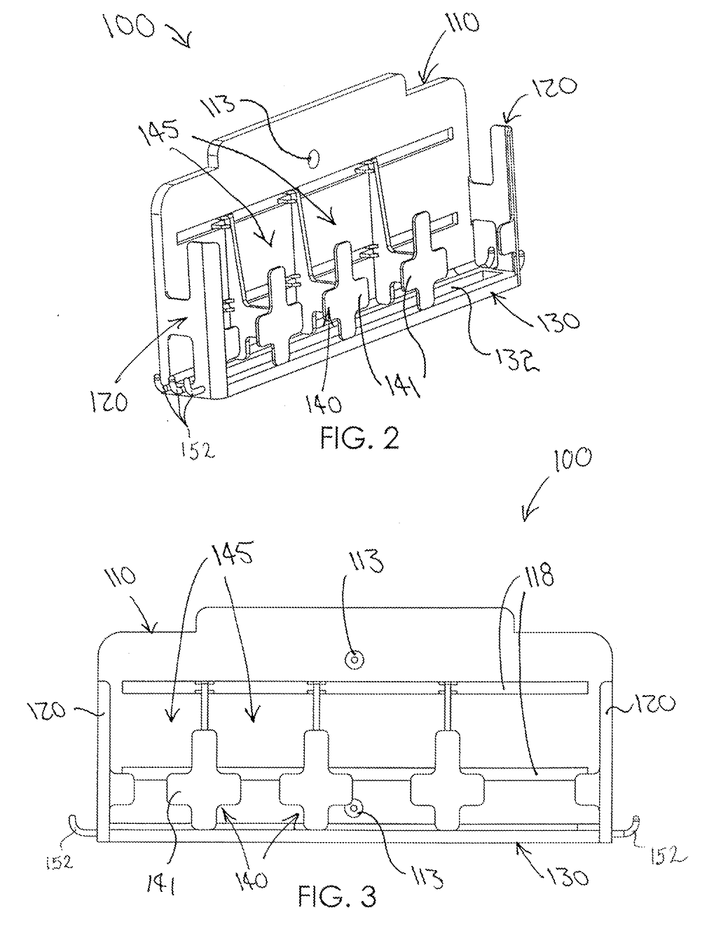

The rear wall 110 may have opposed ends 112a, 112b, and a respective side wall 120 may be adjacent each end 112a, 112b as shown in FIG. 2, for example. The side walls 120 may be directly coupled to the rear wall 110 or otherwise operatively coupled to the rear wall 110. As shown in FIGS. 2 and 3, the rear wall 110 may define a mounting hole 113 to be used in coupling the rear wall 110 to an object (e.g., a wall of a building).

The base 130 extends between the side walls 120 for supporting a lower end 12 of at least one respective mobile communication device 10 (e.g., a cellular telephone, pager, personal data assistant, walkie-talkie, etc.) The base 130 may span only a portion of the distance between the side walls 120, may span the entire distance between the side walls 120, or may extend beyond the side walls 120. In addition, the base 130 may be a continuous element (as shown in FIG. 2) or may consist of multiple distinct elements. The base 130 may define a slot 132 that completely passes therethrough, as shown in FIG. 2. The slot 132 may be configured to receive the lower end 12 of a respective communication device 10, and/or the slot 132 may be sized to pass a charging cord 150 (FIG. 1) therethrough.

The partition 140 may be coupled to the rear wall 110 (FIG. 2) or the base 130 to define a plurality of bays 145. Each bay 145 may be sized to accommodate a respective mobile communication device 10, for example. As such, the bays 145 may be of similar sizes or different sizes. The partition 140 may include a front wall 141 for retaining a respective mobile communication device 10 in a respective bay 145. As shown in FIGS. 2 and 3, the partition 140 may be slidably coupled to the rear wall 110 so that the partition 140 is selectively movable between the side walls 120 to accommodate various mobile communication devices 10. More particularly, the rear wall 110 may define a slot 118 (also referred to herein as a “receiving slot”) extending between the rear wall ends 112a, 112b, and the partition 140 may define a clip 148 that passes through the rear wall slot 118 and couples the partition 140 to the rear wall 110. It should be understood that the size, configuration, and composition of the clip 148 may be altered to make it easier or more difficult to slide the partition 140 along the slot 118. While a slidable attachment between the partition 140 and the rear wall 110 is shown in the accompanying figures, it should be appreciated that other movable attachments may also or alternately be used.

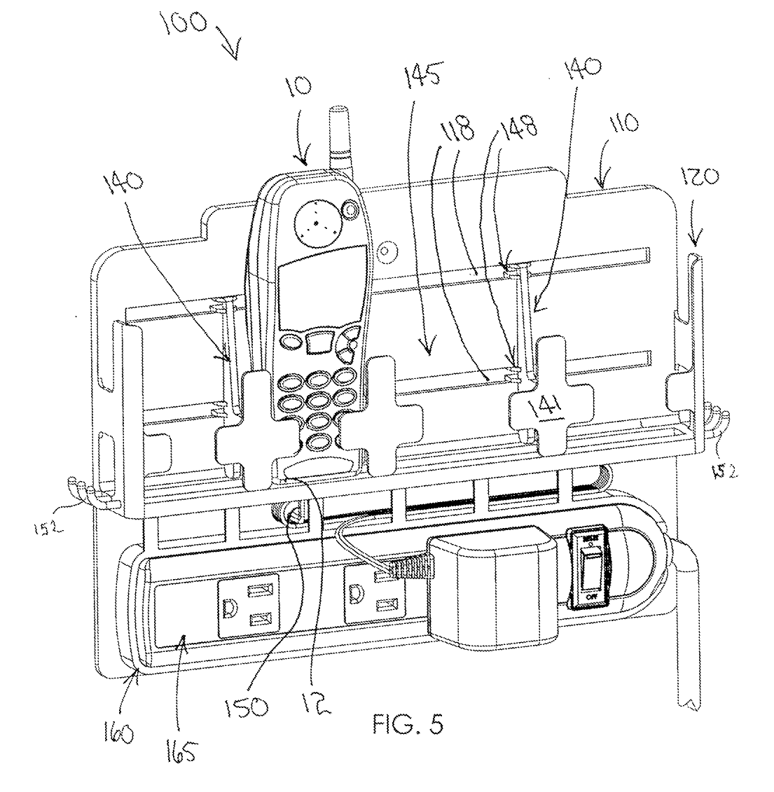

As shown in FIG. 5, an auxiliary framework 160 may be positioned below the base 130 and, more particularly, may be connected to the rear wall 110 or base 130 of the holder 100. The framework 160 may be configured to receive a power strip 165, and the power strip 165 may be received by (or otherwise coupled to) the framework 160.

As shown in FIG. 1, a solar panel 170 may be included. The solar panel 170 may be in electrical communication with the charging cord 150 or in electrical communication with the power strip 165.

Further, at least one and preferably a plurality of hooks 152 may be fixedly attached and extend outwardly from each side wall 120 for holding keys (specifically key chains). This enables a user to place both his keys and cell phone on the holding device 100 for temporary storage, for example, upon returning home after work.

In use, the device 100 may be coupled to a wall (e.g., a home wall or office wall) such as by passing a fastener through the mounting hole 113. The partition 140 may be coupled to the rear wall 110 and moved as desired to define a plurality of bays 145 as discussed above. As shown in the figures, multiple partitions 140 may be utilized to define additional bays 145. The mobile communications device 10 may be placed upon the base 130 in a respective bay 145, and the front wall 141 of the partition 140 may keep the mobile communications device 10 from falling out of the bay 145. The charging cord 150 may pass through the base slot 132 to allow the mobile communications device 10 to be connected to a power source, whereby to charge. By placing a respective mobile communication device 10 in the device 100, it may be easily found and maintained in good condition.

The charging cord 150 may be connected to AC or DC power, and as discussed above, the charging cord 150 may be in electrical communication with the solar panel 170. If the power strip 165 is included, the charging cord 150 may be plugged into the power strip 165. The power strip 165 may be connected to AC or DC power, and as discussed above, the power strip 165 may be in electrical communication with the solar panel 170. The power strip 165 may allow multiple electrical communication devices 10 to conveniently charge.

It is understood that while certain forms of this invention have been illustrated and described, it is not limited thereto except insofar as such limitations are included in the following claims and allowable functional equivalents thereof.

1. A device for holding at least one mobile communication device, said device comprising:
a rear wall having opposed ends;
a respective side wall adjacent each said rear wall end;
a base extending between said side walls for supporting a lower end of at least one respective mobile communication device; and
a partition coupled to said rear wall or said base to define a plurality of bays.

2. The device of claim 1, wherein said base defines a slot completely passing therethrough.

3. The device of claim 1, wherein said partition is slidably coupled to said rear wall and selectively movable between said side walls to allow a respective bay to accommodate various mobile communication devices.

4. The device of claim 1, wherein:
said rear wall defines a slot extending between said rear wall ends;
said partition defines a clip; and
said clip passes through said rear wall slot and couples said partition to said rear wall, said partition being selectively movable between said rear wall ends to allow a respective bay to accommodate various mobile communication devices.

5. The device of claim 1, wherein said partition includes a front wall for retaining a respective mobile communication device in a respective bay.

6. The device of claim 1, further comprising:
a power strip; and
an auxiliary framework below said base, said auxiliary framework being configured to receive said power strip;
wherein said power strip is received by said auxiliary framework.

7. The device of claim 6, wherein said base defines a slot completely passing therethrough, said base slot being sized to pass a charging cord therethrough.

8. The device of claim 6, further comprising a solar panel in electrical communication with said power strip.

9. The device of claim 6, wherein:
said partition is slidably coupled to said rear wall and selectively movable between said side walls to allow a respective bay to accommodate various mobile communication devices; and
said partition includes a front wall for retaining a respective mobile communication device in a respective bay.

10. The device of claim 1, further comprising:
a solar panel; and
a charging cord in electrical communication with said solar panel;
wherein said base defines a slot completely passing therethrough, said base slot being sized to pass said charging cord therethrough.

11. A device for holding at least one mobile communication device, said device comprising:
a rear wall;
a pair of side walls operatively coupled to said rear wall;
a base extending between said side walls for supporting a lower end of at least one respective mobile communication device; and
a partition movably coupled to said rear wall or said base to define a plurality of bays accommodating of various mobile communication devices.

12. The device of claim 11, wherein said partition has a front wall for retaining a respective mobile communication device in a respective bay.

13. The device of claim 11, wherein:
said rear wall defines a receiving slot extending between said side walls;
said partition defines a clip; and
said clip passes through said receiving slot and couples said partition to said rear wall.

14. The device of claim 11, further comprising:
an auxiliary framework below said base; and
a power strip coupled to said auxiliary framework for charging the at least one mobile communication device.

15. The device of claim 14, wherein said base defines a slot complete passing therethrough, said base slot being sized to pass a charging cord therethrough.

16. The device of claim 14, further comprising a solar panel in electrical communication with said power strip.

17. The device of claim 11, wherein said rear wall defines a mounting hole.

18. The device of claim 11, further comprising:
a solar panel; and
a charging cord in electrical communication with said solar panel;
wherein said base defines a slot completely passing therethrough, said base slot being sized to pass said charging cord therethrough.

19. The device of claim 18, wherein:
said rear wall defines a receiving slot extending between said side walls;
said partition defines a clip; and
said clip passes through said receiving slot and couples said partition to said rear wall.

20. The device of claim 19, wherein said partition has a front wall for retaining a respective mobile communication device in a respective bay.
